(19) United States
(12) Patent Application Publication
(10) Pub. No.: US 2018/0315331 A1
(43) Pub. Date: Nov. 1, 2018

(54) ASSISTIVE ASSESSMENT PLATFORM

(71) Applicant: FLORIDA STATE UNIVERSITY RESEARCH FOUNDATION, INC., Tallahassee, FL (US)

(72) Inventors: Yaacov M. Petscher, Tallahassee, FL (US); Cody S. Diefenthaler, Tallahassee, FL (US)

(73) Assignee: FLORIDA STATE UNIVERSITY RESEARCH FOUNDATION, INC., Tallahassee, FL (US)

(21) Appl. No.: 15/966,214

(22) Filed: Apr. 30, 2018

Related U.S. Application Data
(60) Provisional application No. 62/492,629, filed on May 1, 2017.

(51) Int. Cl. G09B 7/02; G09B 5/12; G09B 5/14; H04L 29/08

(52) U.S. Cl. CPC G09B 7/02; H04L 67/141; G09B 5/14; G09B 5/12

(57) ABSTRACT

Various embodiments are directed to an assistive assessment platform directed to improving the efficiency of student assessment administration, the ease of monitoring student progress, evaluator accountability, and the scoring of education outcomes, such as, for example, in pre-kindergarten (pre-K) to twelfth grade environments. The assistive assessment platform described herein allows for the simultaneous remote evaluation of a single student by an arbitrary number of authenticated teachers.

### TECHNICAL FIELD

The present disclosure generally relates to the tools, techniques, and platforms used by teachers to create or administer student educational assessments.

### BACKGROUND

Educational assessments have become an increasingly prevalent tool used to understand, refine, and improve learning opportunities for students. Educational assessments are systematic processes for documenting and utilizing data to establish measurable learning outcomes, gathering information to analyze and interpret to determine whether student learning matches expectations, and using the information to improve learning opportunities. However, as the number of student assessments and types of assessments available for students has increased, coupled with the increased use of educational technology for assessment in the classroom may be burdensome to administer and manage the educational assessments.

### BRIEF DESCRIPTION OF THE DRAWINGS

The detailed description is set forth with reference to the accompanying drawings. The use of the same reference numerals indicates similar or identical components or elements; however, different reference numerals may be used as well to indicate components or elements which may be similar or identical. Various embodiments of the disclosure may utilize elements and/or components other than those illustrated in the drawings, and some elements and/or components may not be present in various embodiments. Depending on the context, singular terminology used to describe an element or a component may encompass a plural number of such elements or components and vice versa.

FIG. 1 depicts an illustrative data flow between various components of an illustrative system architecture for an assistive assessment platform in accordance with one or more embodiments of the disclosure.

FIG. 2 depicts an illustrative data flow between various components of an illustrative system architecture for an assistive assessment platform in accordance with one or more embodiments of the disclosure.

FIG. 3 is an illustrative diagram depicting in example educational assessment.

FIG. 4 depicts illustrative embodiments of a student assessment experience and a teacher scoring experience in accordance with one or more embodiments of the disclosure.

FIG. 5 is an example process flow diagram for an assistive assessment platform in accordance with one or more embodiments of the disclosure.

FIG. 6 schematically illustrates an example architecture of an assistive assessment server in accordance with one or more embodiments of the disclosure.

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar but not necessarily the same or identical components; different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

This disclosure relates to, among other things, systems, methods, computer-readable media, techniques, and methodology for an assistive assessment platform. The assistive assessment platform, which may also be known as the teacher assistive scoring platform, is directed to increase the efficiency of assessment administration, monitoring, and scoring of education outcomes, such as, for example, in pre-kindergarten (pre-K) to twelfth grade environments.

Some educational assessments may be inefficient and have inaccurate scoring of a student's accuracy in response to a presented stimulus. For example, in grades pre-K through grade 5, reading assessment systems frequently rely on the oral response of a student to a presented stimulus, such as stating the name or sound of a letter or reading a non-sense word. Math assessment systems in the same grade may utilize verbal responses for number recognition and math computation skills to assess ability. For middle and high school grade levels, reading and math assessment systems may increasingly rely on computer adaptive technologies, classroom discourse, and observations to understand performance in domains. Currently available educational technologies may be limited as technology-based scoring systems are not able to allow one or more teachers to independently assess student performance using an independent scoring device from the student assessment experience. Common methods for scoring verbal responses include the use of paper and pencil assessments or shared-device technologies. Paper and pencil assessments may require the student and teacher to use separate printed forms, whereby the student provides a verbal response to the presented stimuli on the paper and the teacher concurrently scores student performance on their respective printed form. The limitation of such an approach is that assessments must be printed, administered by the teacher and student separately, hand scored by the teacher, and then entered for each student by the teacher into a local or web-based assessment-entry platform. Shared device technologies exist, whereby assessments may display a stimulus on the screen, the student provides a response, and the teacher scores the item on the same screen the student using. However, this may require the teacher to pass a device back and forth to the student when a tablet or mobile device is used, or the teacher must actively score using dummy-coded keystrokes (e.g., “Z” on a keyboard is used for correct and “M” on a keyboard is used for incorrect) when a laptop or PC is used. Although a shared-technology platform allows for simplicity in scoring, it is cumbersome for scoring and does not allow for multiple-teacher observations or evaluation of student performance. The systems and methods described herein are directed to creating a shared space where a student and one or more teachers share an assessment session, allowing the student to participate in an educational assessment and the teacher(s) to monitor and score the assessment on a separate device in real or near real time.

The systems and methods described herein are directed to an assistive assessment platform for increasing the efficiency of assessment scoring in education environments. In some embodiments, the assistive assessment platform may create a shared assessment session that a student and one or more teachers can simultaneously engage in. As the administration of educational assessments become more technology-based, issues arise that are associated with the administration of student assessments and teacher scoring of the assessments. The assistive assessment platform may bridge the gap between student performance and teacher evaluation by synchronizing the device-based experience for both students and teachers.

In some embodiments, the assistive assessment platform may include different elements, such as a teacher scoring experience (e.g., via a teacher device), a student assessment experience (e.g., via a student device), and/or an assistive assessment server, which may also be referred to as a teacher assistive scoring platform (TASP) communication server. The teacher scoring experience (TSE) may be a web-based presentation for creating shared assessment sessions, recording student responses, and/or scoring the student responses as shown in the shared assessment session. The student assessment experience (SAE) may be a web-based presentation for assessments and item delivery of teacher-created shared assessment sessions. The assistive assessment server may be a virtual machine or a cloud-based hosting solution where information is passed between the shared sessions of the TSE and the SAE. The server may also facilitate communication between the assessment data and any third-party learning management system or learning record stores.

In some embodiments, the assistive assessment platform may create a shared session for administering one or more assessments. In an example embodiment, a teacher may launch an application (e.g., web browser or dedicated application) on a teacher device and may provide authentication credentials. The assistive assessment server may communicate with the teacher device and authenticate the teacher and/or teacher device using the authentication credentials. The teacher may be presented with various assessments that are specifically designed for multi-device proctoring. In some embodiments, the teacher may select an assessment from the presented assessments. The teacher may select a student from a list or otherwise provide student information (e.g., name, class, grade, student ID, etc.). The web browser or dedicated client of the teacher device may create and transmit a request to the assistive assessment server. The request may indicate a selection of an assessment, student information, and the like.

The assistive assessment server may receive the request and may create an assessment lobby. The assessment lobby may be the mechanism by which the teacher device and the student device can share data and be synchronized for the administration of the assessment. The assessment lobby may include at least two properties—an assessment lobby invite code and an assessment lobby token. The assessment lobby invite code may be used by a teacher device or a student device to join the assessment lobby. The assessment lobby token may be used for secure communication between the teacher device and/or the student device with the assistive assessment server. In some embodiments, the assessment lobby invite code may be transmitted to the requesting teacher device. The assessment lobby invite code may be shared with the designated student. The invite code may also be shared with other authenticated teachers who, for example, wish to join the assessment lobby and observe the administration of the selected assessment.

In some embodiments, the student identified to take the assessment may receive the invite code from the teacher. In some embodiments, the teacher may share the code with the student. The student may interact with a student device by launching a web browser or dedicated client of the student device. The student may enter the invite code into the student device. The student device may generate a request to join the assessment lobby identified by the invite code. The assistive assessment server may determine the validity of the invite code. The assistive assessment server may send the student device the assessment lobby token associated with the assessment lobby. The student device may use the assessment lobby token to join the assessment lobby, enabling the student device and the teacher device to be synchronized to the same shared session (e.g., assessment lobby) hosted by the assistive assessment server.

Various illustrative embodiments have been discussed above. These and other example embodiments of the disclosure will be described in more detail hereinafter through reference to the accompanying drawings. The drawings and the corresponding description are provided merely for illustration and are not intended to limit the disclosure in any way. It should be appreciated that numerous other embodiments, variations, and so forth are within the scope of this disclosure.

### Illustrative Use Cases and System Architecture

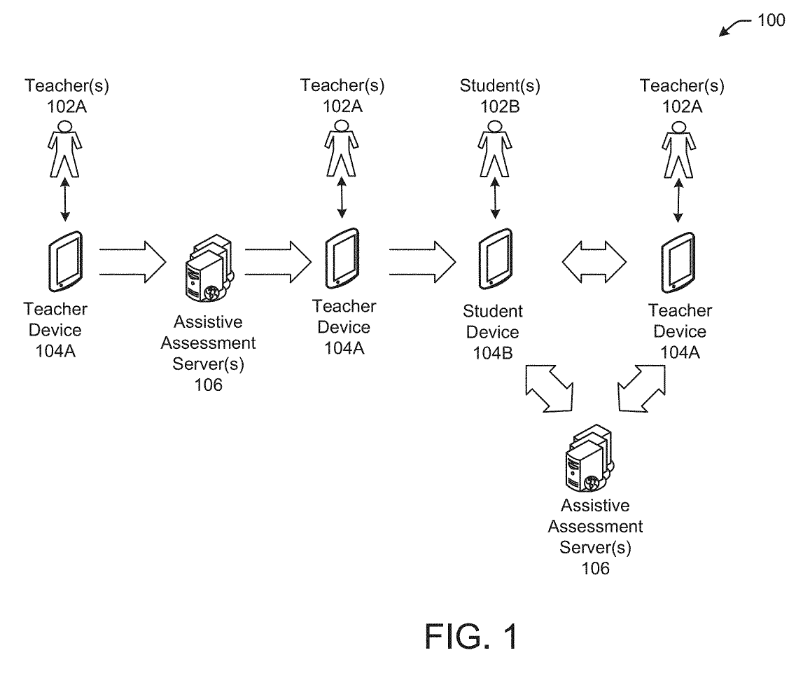

FIG. 1 depicts an illustrative data flow between various components of an illustrative system architecture 100 for an assistive assessment platform in accordance with one or more embodiments of the disclosure. One or more illustrative teacher device(s) 104A operable by one or more teacher(s) 102A and student device(s) 104B operable by one or more student(s) 102B are illustratively depicted in FIG. 1. The teacher device(s) 104A and student device(s) 104B may include any suitable processor-driven computing device including, but not limited to, a desktop computing device, a laptop computing device, a server, a smartphone, a tablet, and so forth. For ease of explanation, the teacher device(s) 104A and student device(s) 104B (collectively user device(s) 104) may be described herein in the singular; however, it should be appreciated that multiple user device(s) 104 may be provided.

In an illustrative embodiment, a teacher of the one or more teacher(s) 102A may interact with a teacher device 104A to launch an application (e.g., web browser or dedicated client application) select an assessment from a list of available assessments. The teacher 102A may interact with the teacher device 104A to select an assessment and enter information associated with a student 102B to whom the assessment is to be administered. The teacher device 104A may generate a request for a shared session (e.g. assessment lobby) that includes the selection of the assessment and student information provided by the teacher 102A. The teacher device 104A may transmit the request to the assistive assessment server 106.

The assistive assessment server 106 may generate a shared session based on the information provided by the teacher device 104A. The assistive assessment server 106 may generate shared session information, such as a shared session invite code and a shared session token. The shared session invite code may be used by a teacher device 104A or a student device 104B to join the shared session. The shared session token may be used for secure communication between the teacher device 104A and/or the student device 104B with the assistive assessment server 106. The assistive assessment server 106 may transmit the shared session information to the teacher device 104A. The teacher device 104A may retain the shared session token and use the token to join the shared session.

The teacher 102A may share the shared session invite code with a student 102B. The teacher 102A may facilitate transmission of the shared session invite code from the teacher device 104A to the student device 104B. In some embodiments, the teacher 102A may share the code with the student 102B who may then enter the code using an application on the student device 104B. The student device 104B may transmit a request to join the shared session to the assistive assessment server 106. The request may include the shared session invite code. The assistive assessment server 106 may validate the student device 104B based on the shared session invite code and may transmit the shared session token associated with the shared session to the student device 104B. The student device 104B may use the shared session token to join the shared session. Likewise, the teacher device 104A may use the shared session token to join the shared session. The student 102B and teacher 102A may interact with their respective devices to complete the assessment, the results of which are transmitted back to the assistive assessment server 106 for analysis and retention.

In some embodiments, the teacher 102A may also share the shared session invite code with one or more additional teachers of the one or more teacher(s) 102A. The teacher 102A may facilitate transmission of the shared session invite code from the teacher device 104A to the teacher devices 104A of the one or more additional teachers in a similar manner as for the student device 104B. In some embodiments, the teacher 102A may share the code with the one or more additional teachers, who may each then enter the code using an application on their own teacher device 104A. These additional teacher devices 104A may transmit a request to join the shared session to the assistive assessment server 106. The request may include the shared session invite code. The assistive assessment server 106 may validate the teacher devices 104A based on the shared session invite code and may transmit the shared session token associated with the shared session to the teacher devices 104A. The teacher devices 104A may use the shared session token to join the shared session. In this manner, any number of teachers can join a shared session with the student 102B for a simultaneous, remote evaluation. The teachers 102A may interact with their respective devices to complete their own assessments of the student 102B, the results of which are transmitted back to the assistive assessment server 106 for analysis and retention.

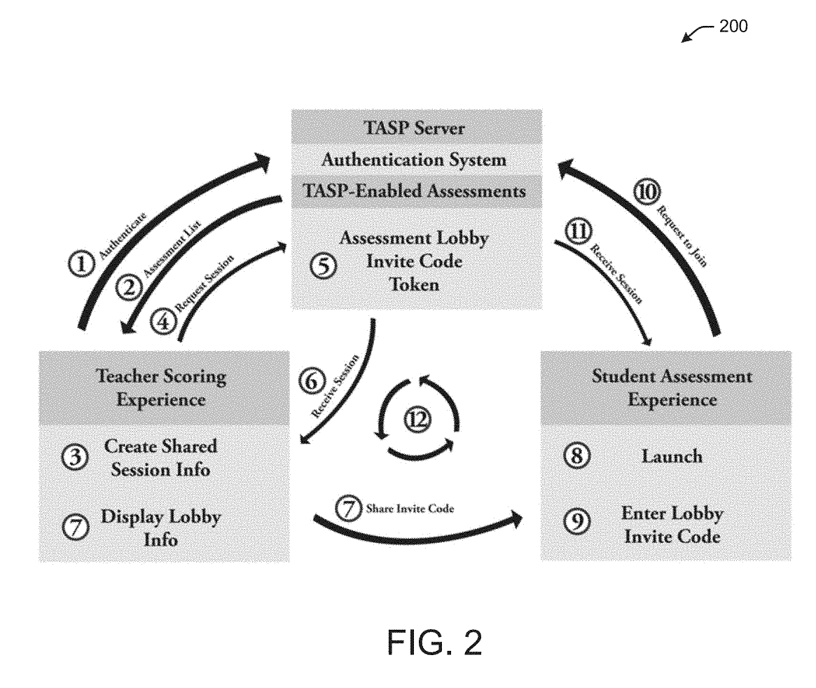

FIG. 2 depicts an illustrative data flow 200 between various components of an illustrative system architecture for an assistive assessment platform in accordance with one or more embodiments of the disclosure. The architecture of the assistive assessment platform may include elements, such as: (1) a Teacher Scoring Experience (TSE), also referred to as a teacher device 104A, a web-based presentation for creating shared assessment sessions and recording student responses; (2) a Student Assessment Experience (SAE), also referred to as a student device 104B, a web-based presentation for assessments and item delivery of teacher-created shared assessment sessions; and/or (3) a teacher assistive scoring platform (TASP) Communication Server, also known as an assistive assessment server 106, a virtual machine or cloud-based hosting solution where information is passed between the shared sessions of TSE and SAE. The TASP Server may also facilitate communication between assessment data and any third-party Learning Management Systems or Learning Record Stores.

FIG. 2 depicts an example data flow for creating a shared session for an assistive assessment platform. At exchange 1, a teacher 102A may launch a TSE application on their web-enabled device (e.g., teacher device 104A) and authenticate their credentials with the TASP Server. At exchange 2, upon authentication, the teacher 102A may be presented with a variety of available assessments via the TSE. The assessments may be designed specifically for multi-device proctoring within the assistive assessment platform. At exchange 3, the teacher 102A may select an assessment from the list of available assessments. The teacher 102A may enter student information such, as name, class, grade, student identifier, or the like or the teacher 102A may select the student 102B from a list of students who were previously administered an assessment using the assistive assessment platform

At exchange 4, a request for creating a shared session is sent to the TASP Server. The request may include an indication of the selected assessment and any student information provided. At exchange 5, the TASP server may receive the request and may create a shared session, known as an Assessment Lobby, where messages between TSE and SAE are transmitted. The assessment lobby may be associated with an Assessment Lobby Invite Code, used to join the lobby, and an Assessment Lobby Token used for secure communication between both TSE- and SAE-clients with the TASP Server. At exchange 6, the TSE may receive and retain the shared session information (e.g., the Assessment Lobby Invite Code and Token). The shared session information allows the TSE to communicate with the Assessment Lobby hosted on the TASP Server.

At exchange 7, the Assessment Lobby Invite Code is displayed on the TSE for the teacher 102A to share with the designated student 102B. At exchange 8, the student 102B may launch the SAE on their web-enabled device (e.g., student device 104B). At exchange 9, the student 102B may enter the Lobby Invite Code into the SAE. At exchange 10, the SAE may generate and send a request to the TASP Server to join the Assessment Lobby identified by the invite code. At exchange 11, the TASP Server may validate the SAE using the assessment lobby token. Upon validation, the TASP Server may send to the SAE the associated Assessment Lobby Token. At exchange 12, the SAE and TSE may be synchronized to the same shared session hosted on the TASP Server and the assessment may be administered and scored accordingly.

In some embodiments, at exchange 7 the Assessment Lobby Invite Code displayed on the TSE for the teacher 102A may also be shared by the teacher 102A with other authenticated teachers 102A who wish to join the Assessment Lobby and observe the assessment being administered. These additional teachers 102A can launch their own TSEs on their own web-enabled devices (e.g., teacher devices 104A) and can authenticate their credentials with the TASP Server in a similar manner as the initial teacher 102A. These additional teachers 102A may each enter the Lobby Invite Code into their TSE to request to the TASP Server to join the Assessment Lobby identified by the invite code in a similar manner as the student 102B. The TASP Server may validate each of the TSEs using the assessment lobby token. Upon validation, the TASP Server may send to each validated TSE the associated Assessment Lobby Token. In this manner, the SAE and each of the validated TSEs may be synchronized to the same shared session hosted on the TASP Server and one or more individual teacher assessments may be administered and scored accordingly.

Allowing two or more teachers to provide simultaneous, individual teacher assessments of the same student offers several advantages over the use of a single evaluator. For example, the use of multiple evaluators allows for a comparison to be made between the evaluators themselves. Due to individual differences among teachers, two teachers may score the same response by the student 102B differently. In some embodiments, the TASP Server tracks these differences, to determine, for example, the intra-reliability of the teacher assessments. This data can in turn be used to monitor for, and address, any discovered biases or inconsistencies in the teacher assessments.

In some embodiments, the TASP Server generates a score (also referred to as a reliability score) for each teacher. This score can be based at least in part on a question-by-question or overall comparison of the teacher's assessments to the average or most common assessments from all of the teachers. Alternatively, the assessment received from the initial teacher 102A that set up the shared session can be considered the correct assessment, and deviations from this assessment in the other teacher's assessments can be tracked. In yet other embodiments, the assessment received from the teacher having the highest current score (from, e.g., previous assessments) can be considered the correct assessment, and deviations from this assessment in the other teacher's assessments can be tracked.

For example, if five teachers are evaluating a student, and only one of the five teachers scores question four as “incorrect,” the TASP Server can record and later report on this inconsistency. Similarly, the TASP Server can record and later report on one of the five teachers providing an assessment (for example, 80% correct) which differs significantly from the assessments provided by the other teachers (for example, an average of 45% correct). Over time, the TASP Server can determine which teachers are consistent outliers (e.g., those having low reliability scores) and which teachers provide evaluations without these inconsistencies (e.g., those having high reliability scores). In some embodiments, the TASP Server can use these scores to provide relative weights to the teacher assessments. For example, an assessment from a teacher having a low reliability score can be given less weight. Conversely, an assessment from a teacher having a high reliability score can be given more weight.

These reliability scores may or may not be visible to the teachers 102A. In some embodiments, these scores are periodically provided to a teacher evaluator or to the teachers 102A themselves for training purposes. In some embodiments, these reports can be triggered based at least in part on predetermined conditions. For example, a TASP Server report can indicate that a particular teacher has a sufficiently low reliability score (below, for example, a predetermined reliability threshold) to trigger an intercession.

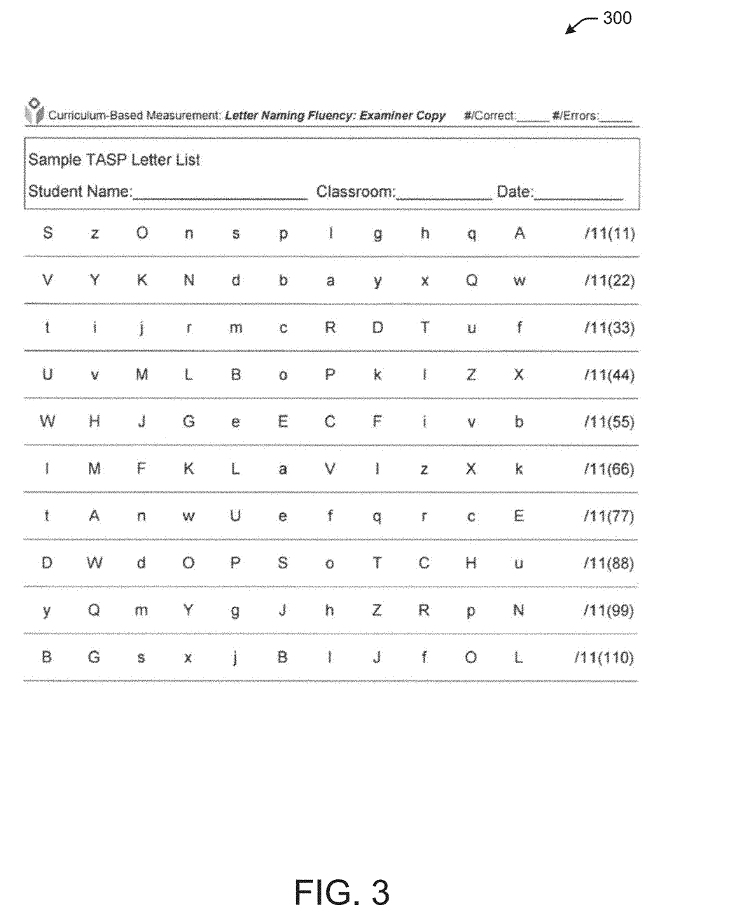

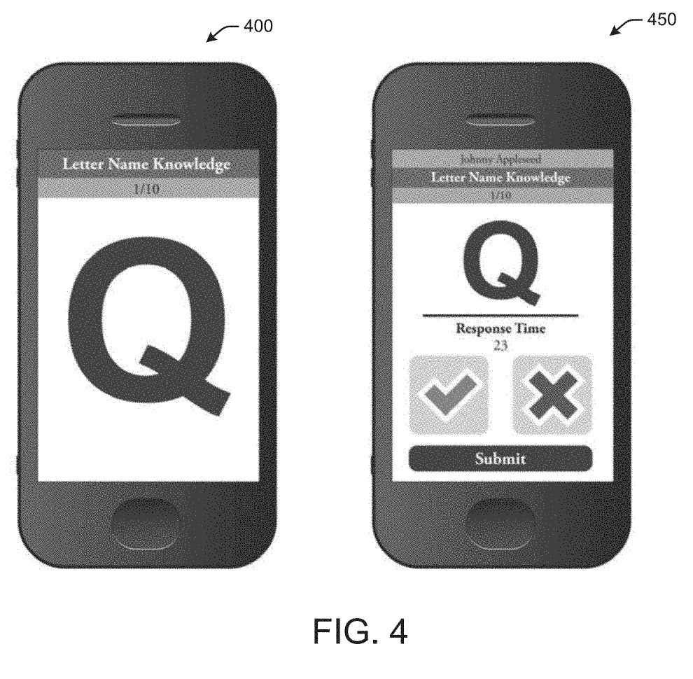

FIG. 3 is an illustrative diagram depicting in example educational assessment. The assistive assessment platform creates a shared assessment session for the assessment of oral or silent accuracy in educational assessment that both a student 102B and a teacher 102A can use simultaneously. As assessments move to be technology-based, groups are struggling with how to integrate student assessment and teacher scoring. The assistive assessment platform bridges the gap between student performance and teacher evaluation by synchronizing the experiences for both. FIG. 3 depicts a sample letter name fluency task 300 where students 102B are given 60 seconds to accurately state the name of the letter. The goal of the assistive assessment platform is to remove the to: 1) print forms for the letter name fluency task, 2) have the student 102B and teacher 102A use separate forms for performance and scoring, 3) have the teacher 102A score the assessment, and 4) have the teacher 102A manually enter a set of scores from this protocol. The assistive assessment platform transforms the protocol in FIG. 3 to what is depicted in FIG. 4.

FIG. 4 depicts illustrative embodiments of a student assessment experience 400 and a teacher scoring experience 450 in accordance with one or more embodiments of the disclosure. The student assessment experience 400 shows the presentation of the items as seen by the student 102B, which may include an identification of the type of task for the assessment, an indication of the number of elements in the task, and the presentation of an element for the assessment. The teacher scoring experience 450 shows the presentation and scoring of items as seen by the teacher 102A using a joint session. The teacher scoring device 450 will have control of the assessment time (e.g., Response Time) and will have the ability to stop the assessment after the pre-defined amount of time has been reached. The teacher scoring experience may show an identification of the student being assessed, an identification of the type of task for the assessment, an indication of the number of elements in the task, a depiction of the element for the assessment as shown to the student, and user interface elements that permit the teacher to score the task based on the response by the student 102B.

In some embodiments, the user interface elements that permit the teacher to score the task include a “correct” answer element and an “incorrect” answer element. Alternatively or in addition to these answer elements, the user interface elements that permit the teacher to score the task can include one or more “allowable” responses. For example, if a multiple-choice question is posed to the student 102B, the allowable responses can include each of the available answer choices, one or more of which can be selected by the teacher 102A depending on the student response. The teacher 102A can select between these answer elements depending on the student's response to the element presented for the assessment.

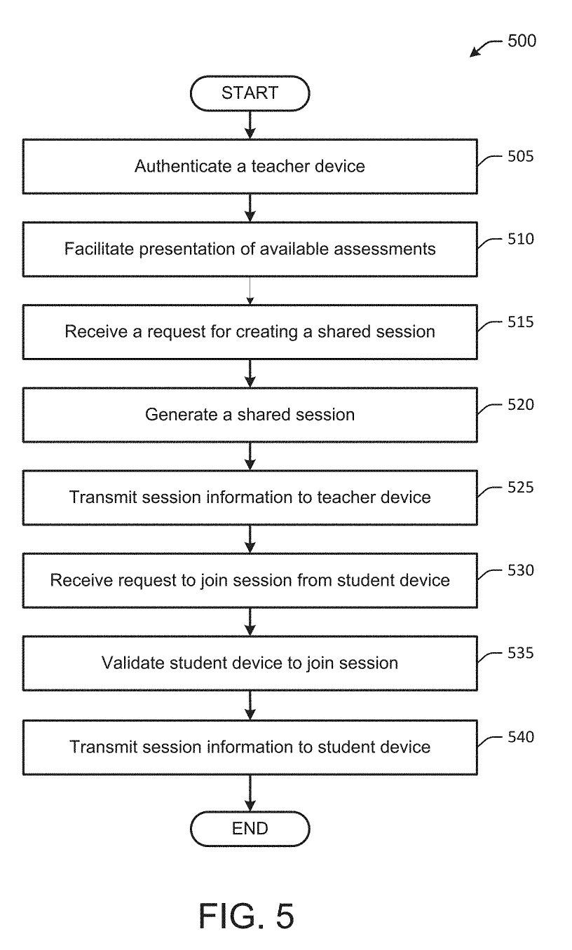

FIG. 5 is an example process 500 flow diagram for an assistive assessment platform in accordance with one or more embodiments of the disclosure. At block 505, a teacher device 104A may be authenticated. In some embodiments, a teacher 102A may interact with a teacher device 104A using a web browser or a dedicated application. The teacher 102A may provide authentication credentials (e.g., username and password, authentication token, etc.). The authentication credentials may be transmitted to the assistive assessment server 106 for authentication. The assistive assessment server 106 may authenticate the teacher 102A based on the authentication credentials provided via the teacher device 104A.

At block 510, presentation of available assessments may be facilitated. In some embodiments, the authentication credentials may be associated with a profile associated with the teacher 102A and/or teacher device 104A. The assistive assessment server 106 may retrieve a listing of assessments available for the teacher 102A and/or teacher device 104A. In some embodiments, the assessments may be presented by grade level, assessment type, availability (e.g., based on type of teacher device 104A or student device 104B, assessments specific to an identified student 102B, or the like). In some embodiments, the assessments may be designed specifically for multi-device proctoring, such as described in the context of the systems and methods described herein.

At block 515, a request for creating a shared session may be received. The teacher 102A may select from the list of available of assessments using the teacher device 104A. In some embodiments, the teacher 102A may provide student information via the browser or dedicated application associated with the assistive assessment platform. The teacher 102A may enter student information, such as name, class identifier, grade level identifier, student identifier, or the like. In some embodiments, the teacher 102A may select a student 102B from a list indicative of students that previously used the assistive assessment platform. The web browser or dedicated application may generate and transmit a request for a shared session for an assessment to an assistive assessment server 106.

At block 520, a shared session may be generated. In some embodiments, the assistive assessment server 106 may generate the shared session (also known as the assessment lobby) based at least in part on the identified assessment to be administered, the student identified for the assessment, and the like. The assistive assessment server 106 may create the shared session where messages between the teacher device 104A and the student device 104B are transmitted. The shared session may be associated with shared session information. Shared session information may include, but is not limited to, the shared session invite code (also known as the assessment lobby invite code) and the shared session token (also known as the assessment lobby token). The shared session invite code may be a string that includes alphanumeric characters, symbols, and the like. In some embodiments, the transmission of the shared session invite code may be encrypted. The shared session token may be a token that is used to secure communication between the teacher device 104A, student device 104B, and the assistive assessment server 106.

At block 525, the share session information may be transmitted to the teacher device 104A. The assistive assessment server 106 may generate a response and transmit the shared session information to the teacher device 104A in response to the request for the shared session. In some embodiments, the teacher device 104A may receive and retain the shared session information, which allows the teacher device 104A to communicate with and through the shared session hosted by the assistive assessment server 106.

In some embodiments, the shared session invite code may be displayed on the teacher device 104A for the teacher 102A to share with the designated student 102B. The shared session invite code may be shared with the student 102B by showing the student the shared session invite code on the teacher device 104A (e.g., the student writes down the invite code) or by sharing the shared session invite code with the student (e.g., electronically via text, email, voice message, or the like). The shared session invite code may also be shared with other teachers associated with the assistive assessment platform (e.g., have the necessary authentication credentials and satisfy any pertinent or relevant rules to access to assessment associated or designated for the student). The other teachers may wish to join the shared session to observe the assessment administered to the designated student 102B.

At block 530, a request to join a session may be received from a student device 104B. In some embodiments, the student 102B may interact with a student device 104B to launch a web browser or dedicated client application. The student device 104B may transmit a request to join the shared session generated at the request of the teacher 102A. The request may include the shared session invite code.

At block 535, the student device 104B may be validated. The assistive assessment server 106 may receive the request from the student device 104B to join the shared session. The assistive assessment server 106 may validate the student device 104B using the shared session invite code.

At block 540, session information may be transmitted to the student device 104B. The assistive assessment server 106 may transmit the shared session token associated with the shared session generated at the request of the teacher 102A to the student device 104B. The student device 104B may receive the shared session token, which may be used to enable the student device 104B to access the shared session. The student device 104B and the teacher device 104A may be synchronized to the same shared session hosted by the assistive assessment server 106.

In some embodiments, the assistive assessment server 106 may act as the authority to all clients (e.g., student devices 104B, teacher devices 104A, etc.). For an identified assessment, elements of the assessment may be delivered or transmitted from the assistive assessment server 106 to the teacher device 104A and the student device 104B using formats associated with the respective type of client (e.g., student or teacher), as discussed with regard to FIG. 4. In some embodiments, the student 102B may be presented with an element prompt via the student device 104B and may respond verbally. The teacher 102A may be presented with scoring information and user interface elements for recording the verbal response of the student 102B via the teacher device 104A. When the teacher 102A has completed scoring the element using the teacher device 104A, the scoring data may be transmitted to the shared session of the assistive assessment server 106. The assistive assessment server 106 may retain the scoring data and assessment and deliver the next element of the assessment to the clients (e.g., student device 104B, teacher device 104A) or terminate the assessment based on predetermined stop criteria (e.g., timing, number of elements, obtaining a minimum threshold score, etc.) or a command received from either of the client devices.

Upon completion or termination of an assessment, the teacher device 104A and student device 104B may display their respective results. The teacher device 104A may display detailed results to the teacher 102A who can then confirm the data being recorded. The teacher 102A may print or email the results, or if the assessment is integrated with a Learning Management Systems or Learning Record Store, can push the results to those endpoints. The student device 104B, when appropriate, may also show the student their proficiency metrics based on the administered assessment. When the original teacher 102A, who requested the shared session, exists the shared session, the assistive assessment server 106 may terminate the shared session and may set the shared session invite code as well as associated shared session tokens as expired, preventing any subsequent use of the shared session information.

### Illustrative Computer Architecture

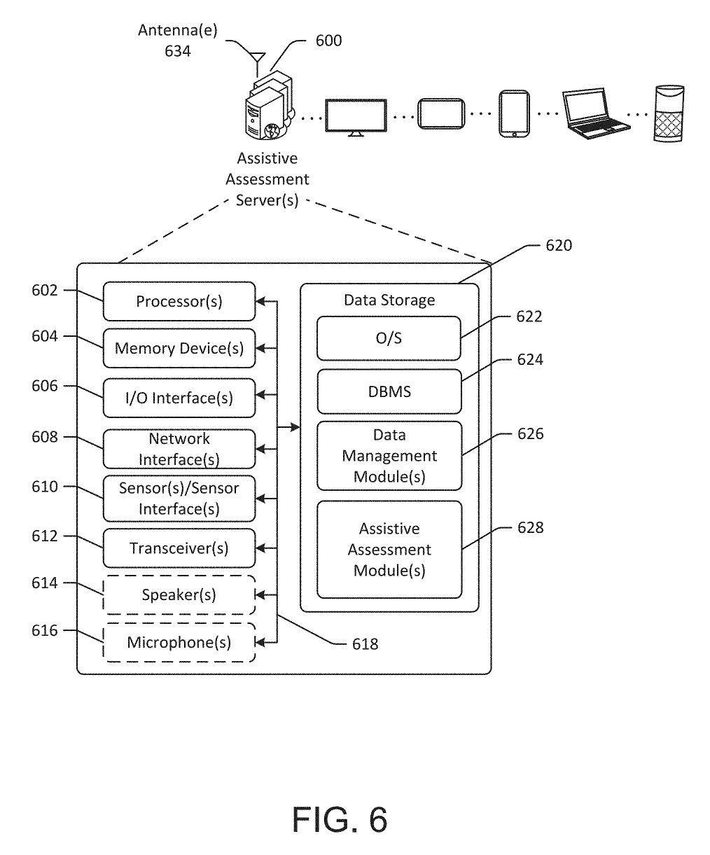

FIG. 6 is a schematic block diagram of one or more illustrative assistive assessment server(s) 600 in accordance with one or more example embodiments of the disclosure. The assistive assessment server(s) 600 may include any suitable computing device including, but not limited to, a server system, a mobile device such as a smartphone, a tablet, an e-reader, a wearable device, or the like; a desktop computer; a laptop computer; a content streaming device; a set-top box; or the like. The assistive assessment server(s) 600 may correspond to an illustrative device configuration for the assistive assessment servers of FIGS. 1-5.

The assistive assessment server(s) 600 may be configured to communicate via one or more networks with one or more servers, user devices, or the like. The assistive assessment server(s) 600 may be configured to coordinate transmission of data between teacher devices 104A and student devices 104B to administer assessments and record the scoring data submitted by the teacher device 104A based on administration of the assessment via the teacher device 104A and student device 104B.

The assistive assessment server(s) 600 may be configured to communicate via one or more networks. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the assistive assessment server(s) 600 may include one or more processors (processor(s)) 602, one or more memory devices 604 (generically referred to herein as memory 604), one or more input/output (I/O) interfaces 606, one or more network interfaces 608, one or more sensors or sensor interfaces 610, one or more transceivers 612, one or more optional speakers 614, one or more optional microphones 616, and data storage 620. The assistive assessment server(s) 600 may further include one or more buses 618 that functionally couple various components of the assistive assessment server(s) 600. The assistive assessment server(s) 600 may further include one or more antenna(e) 634 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 618 may include at least one of a system bus, a memory bus, an address bus, or a message bus, and may permit exchange of information (e.g., data (including computer-executable code), signaling, etc.) between various components of the assistive assessment server(s) 600. The bus(es) 618 may include, without limitation, a memory bus or a memory controller, a peripheral bus, an accelerated graphics port, and so forth. The bus(es) 618 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnect (PCI) architecture, a PCI-Express architecture, a Personal Computer Memory Card International Association (PCMCIA) architecture, a Universal Serial Bus (USB) architecture, and so forth.

The memory 604 of the assistive assessment server(s) 600 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 604 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 604 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 620 may include removable storage and/or non-removable storage including, but not limited to, magnetic storage, optical disk storage, and/or tape storage. The data storage 620 may provide non-volatile storage of computer-executable instructions and other data. The memory 604 and the data storage 620, removable and/or non-removable, are examples of computer-readable storage media (CRSM) as that term is used herein.

The data storage 620 may store computer-executable code, instructions, or the like that may be loadable into the memory 604 and executable by the processor(s) 602 to cause the processor(s) 602 to perform or initiate various operations. The data storage 620 may additionally store data that may be copied to the memory 604 for use by the processor(s) 602 during the execution of the computer-executable instructions. Moreover, output data generated as a result of execution of the computer-executable instructions by the processor(s) 602 may be stored initially in the memory 604, and may ultimately be copied to the data storage 620 for non-volatile storage.

More specifically, the data storage 620 may store one or more operating systems (O/S) 622; one or more database management systems (DBMS) 624; and one or more program module(s), applications, engines, computer-executable code, scripts, or the like such as, for example, one or more data management module(s) 626 and/or one or more assistive assessment module(s) 628. Some or all of these module(s) may be sub-module(s). Any of the components depicted as being stored in the data storage 620 may include any combination of software, firmware, and/or hardware. The software and/or firmware may include computer-executable code, instructions, or the like that may be loaded into the memory 604 for execution by one or more of the processor(s) 602. Any of the components depicted as being stored in the data storage 620 may support functionality described in reference to corresponding components named earlier in this disclosure.

The data storage 620 may further store various types of data utilized by components of the assistive assessment server(s) 600. Any data stored in the data storage 620 may be loaded into the memory 604 for use by the processor(s) 602 in executing computer-executable code. In addition, any data depicted as being stored in the data storage 620 may potentially be stored in one or more datastore(s) and may be accessed via the DBMS 624 and loaded in the memory 604 for use by the processor(s) 602 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like. In FIG. 6, an example datastore(s) may include, for example, web content, advertisement campaigns, advertisements, assessment information, content items, and/or other information.

The processor(s) 602 may be configured to access the memory 604 and execute computer-executable instructions loaded therein. For example, the processor(s) 602 may be configured to execute computer-executable instructions of the various program module(s), applications, engines, or the like of the assistive assessment server(s) 600 to cause or facilitate various operations to be performed in accordance with one or more embodiments of the disclosure. The processor(s) 602 may include any suitable processing unit capable of accepting data as input, processing the input data in accordance with stored computer-executable instructions, and generating output data. The processor(s) 602 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 602 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 602 may be capable of supporting any of a variety of instruction sets.

Referring now to functionality supported by the various program module(s) depicted in FIG. 6, the data management module(s) 626 may include computer-executable instructions, code, or the like that responsive to execution by one or more of the processor(s) 602 may perform functions including, but not limited to, managing requests and responses received from teacher devices 104A and student devices 104B, identifying and obtaining assessments, transmitting data to the assistive assessment module 628, and the like.

The assistive assessment module(s) 628 may include computer-executable instructions, code, or the like that responsive to execution by one or more of the processor(s) 602 may perform functions including, but not limited to, generating shared session information, such as the shared session invite code and shared session token, administering assessments to an identified student 102B by transmitting elements of the assessment to the teacher device 104A and student device 104B, receiving responses and scoring data from the respective devices, terminating the shared session, and the like.

Referring now to other illustrative components depicted as being stored in the data storage 620, the O/S 622 may be loaded from the data storage 620 into the memory 604 and may provide an interface between other application software executing on the assistive assessment server(s) 600 and the hardware resources of the assistive assessment server(s) 600. More specifically, the O/S 622 may include a set of computer-executable instructions for managing hardware resources of the assistive assessment server(s) 600 and for providing common services to other application programs (e.g., managing memory allocation among various application programs). In certain example embodiments, the O/S 622 may control execution of the other program module(s) to dynamically enhance characters for content rendering. The O/S 622 may include any operating system now known or which may be developed in the future including, but not limited to, any server operating system, any mainframe operating system, or any other proprietary or non-proprietary operating system.

The DBMS 624 may be loaded into the memory 604 and may support functionality for accessing, retrieving, storing, and/or manipulating data stored in the memory 604 and/or data stored in the data storage 620. The DBMS 624 may use any of a variety of database models (e.g., relational model, object model, etc.) and may support any of a variety of query languages. The DBMS 624 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the assistive assessment server(s) 600 is a mobile device, the DBMS 624 may be any suitable lightweight DBMS optimized for performance on a mobile device.

Referring now to other illustrative components of the assistive assessment server(s) 600, the input/output (I/O) interface(s) 606 may facilitate the receipt of input information by the assistive assessment server(s) 600 from one or more I/O devices as well as the output of information from the assistive assessment server(s) 600 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the assistive assessment server(s) 600 or may be separate. The I/O devices may further include, for example, any number of peripheral devices such as data storage devices, printing devices, and so forth.

The I/O interface(s) 606 may also include an interface for an external peripheral device connection such as universal serial bus (USB), FireWire, Thunderbolt, Ethernet port or other connection protocol that may connect to one or more networks. The I/O interface(s) 606 may also include a connection to one or more of the antenna(e) 634 to connect to one or more networks via a wireless local area network (WLAN) (such as Wi-Fi) radio, Bluetooth, ZigBee, and/or a wireless network radio, such as a radio capable of communication with a wireless communication network such as a Long Term Evolution (LTE) network, WiMAX network, 3G network, etc.

The assistive assessment server(s) 600 may further include one or more network interface(s) 608 via which the assistive assessment server(s) 600 may communicate with any of a variety of other systems, platforms, networks, devices, and so forth. The network interface(s) 608 may enable communication, for example, with one or more wireless routers, one or more host servers, one or more web servers, and the like via one or more networks.

The antenna(e) 634 may include any suitable type of antenna depending, for example, on the communications protocols used to transmit or receive signals via the antenna(e) 634. Non-limiting examples of suitable antennae may include directional antennae, non-directional antennae, dipole antennae, folded dipole antennae, patch antennae, multiple-input multiple-output (MIMO) antennae, or the like. The antenna(e) 634 may be communicatively coupled to one or more transceivers 612 or radio components to which or from which signals may be transmitted or received.

As previously described, the antenna(e) 634 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA2000, etc.), 4G standards (e.g., Long-Term Evolution (LTE), WiMax, etc.), direct satellite communications, or the like.

The antenna(e) 634 may additionally, or alternatively, include a Wi-Fi antenna configured to transmit or receive signals in accordance with established standards and protocols, such as the IEEE 802.11 family of standards, including via 2.4 GHz channels (e.g., 802.11b, 802.11g, 802.11n), 5 GHz channels (e.g., 802.11n, 802.11ac), or 60 GHz channels (e.g., 802.11ad). In alternative example embodiments, the antenna(e) 634 may be configured to transmit or receive radio frequency signals within any suitable frequency range forming part of the unlicensed portion of the radio spectrum.

The antenna(e) 634 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 612 may include any suitable radio component(s) for—in cooperation with the antenna(e) 634—transmitting or receiving radio frequency (RF) signals in the bandwidth and/or channels corresponding to the communications protocols utilized by the assistive assessment server(s) 600 to communicate with other devices. The transceiver(s) 612 may include hardware, software, and/or firmware for modulating, transmitting, or receiving —potentially in cooperation with any of antenna(e) 634—communications signals according to any of the communications protocols discussed above including, but not limited to, one or more Wi-Fi and/or Wi-Fi direct protocols, as standardized by the IEEE 802.11 standards, one or more non-Wi-Fi protocols, or one or more cellular communications protocols or standards. The transceiver(s) 612 may further include hardware, firmware, or software for receiving GNSS signals. The transceiver(s) 612 may include any known receiver and baseband suitable for communicating via the communications protocols utilized by the assistive assessment server(s) 600. The transceiver(s) 612 may further include a low noise amplifier (LNA), additional signal amplifiers, an analog-to-digital (A/D) converter, one or more buffers, a digital baseband, or the like.

The sensor(s)/sensor interface(s) 610 may include or may be capable of interfacing with any suitable type of sensing device such as, for example, inertial sensors, force sensors, thermal sensors, and so forth. Example types of inertial sensors may include accelerometers (e.g., MEMS-based accelerometers), gyroscopes, and so forth.

The speaker(s) 614 may be any device configured to generate audible sound. The microphone(s) 616 may be any device configured to receive analog sound input or voice data.

It should be appreciated that the program module(s), applications, computer-executable instructions, code, or the like depicted in FIG. 6 as being stored in the data storage 620 are merely illustrative and not exhaustive and that processing described as being supported by any particular module may alternatively be distributed across multiple module(s) or performed by a different module. In addition, various program module(s), script(s), plug-in(s), Application Programming Interface(s) (API(s)), or any other suitable computer-executable code hosted locally on the assistive assessment server(s) 600, and/or hosted on other computing device(s) accessible via one or more networks, may be provided to support functionality provided by the program module(s), applications, or computer-executable code depicted in FIG. 6 and/or additional or alternate functionality. Further, functionality may be modularized differently such that processing described as being supported collectively by the collection of program module(s) depicted in FIG. 6 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 6 may be implemented, at least partially, in hardware and/or firmware across any number of devices.

It should further be appreciated that the assistive assessment server(s) 600 may include alternate and/or additional hardware, software, or firmware components beyond those described or depicted without departing from the scope of the disclosure. More particularly, it should be appreciated that software, firmware, or hardware components depicted as forming part of the assistive assessment server(s) 600 are merely illustrative and that some components may not be present or additional components may be provided in various embodiments. While various illustrative program module(s) have been depicted and described as software module(s) stored in the data storage 620, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

One or more operations of the methods, process flows, and use cases of FIGS. 1-5 may be performed by a device having the illustrative configuration depicted in FIG. 6, or more specifically, by one or more engines, program module(s), applications, or the like executable on such a device. It should be appreciated, however, that such operations may be implemented in connection with numerous other device configurations.

The operations described and depicted in the illustrative methods and process flows of FIGS. 1-6 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 1-6 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A non-transitory computer-readable medium storing computer-executable instructions which, when executed by a processor, cause the processor to perform operations comprising:
receiving, from a first device, a request for an assistive assessment shared session, wherein the request comprises an indication of a selection of an assessment and data associated with a user;
generating a shared session and shared session information, wherein the shared session information comprises a code associated with the shared session and a token associated with the shared session;
transmitting the shared session information to the first device;
receiving, from a second device, a request to join the assistive assessment shared session, wherein the request to join the assistive assessment shared session comprises the code;
validating the second device based at least in part on the code;
transmitting, to the second device, the token associated with the shared session; and
hosting the shared session for the first device and the second device based at least in part on the token.

2. The non-transitory computer-readable medium of claim 1, wherein the operations further comprise:
receiving, from the first device, scoring data associated with the assessment and the user.

3. The non-transitory computer-readable medium of claim 2, wherein the operations further comprise:
receiving, from a third device, a second request to join the assistive assessment shared session, wherein the second request to join the assistive assessment shared session comprises the code;
validating the third device based at least in part on the code;
transmitting, to the third device, the token associated with the shared session; and
hosting the shared session for the first device, the second device, and the third device based at least in part on the token.

4. The non-transitory computer-readable medium of claim 3, wherein the operations further comprise:
receiving, from the third device, scoring data associated with the assessment and the user.

5. The non-transitory computer-readable medium of claim 4, wherein the operations further comprise:
comparing the scoring data received from the first device to the scoring data received from the third device.

6. The non-transitory computer-readable medium of claim 5, wherein the operations further comprise:
generating one or more reliability scores based at least in part on the comparison of the scoring data received from the first device and the third device.

7. The non-transitory computer-readable medium of claim 1, wherein the operations further comprise:
transmitting, during the shared session, one or more assessment questions to the second device.

8. An assistive assessment platform comprising:
a teacher assistive scoring platform (TASP) communication server, the TASP communication server comprising at least one processor, wherein the at least one processor is configured to:
receive, from a first device, a request for an assistive assessment shared session, wherein the request comprises an indication of a selection of an assessment and data associated with a user;
generate a shared session and shared session information, wherein the shared session information comprises a code associated with the shared session and a token associated with the shared session;
transmit the shared session information to the first device;
receive, from a second device, a request to join the assistive assessment shared session, wherein the request to join the assistive assessment shared session comprises the code;
validate the second device based at least in part on the code;
transmit, to the second device, the token associated with the shared session; and
host the shared session for the first device and the second device based at least in part on the token.

9. The assistive assessment platform of claim 8, wherein the at least one processor is further configured to:
receive, from the first device, scoring data associated with the assessment and the user.

10. The assistive assessment platform of claim 9, wherein the at least one processor is further configured to:
receive, from a third device, a second request to join the assistive assessment shared session, wherein the second request to join the assistive assessment shared session comprises the code;
validate the third device based at least in part on the code;
transmit, to the third device, the token associated with the shared session; and
host the shared session for the first device, the second device, and the third device based at least in part on the token.

11. The assistive assessment platform of claim 10, wherein the at least one processor is further configured to:
receive, from the third device, scoring data associated with the assessment and the user.

12. The assistive assessment platform of claim 11, wherein the at least one processor is further configured to:
compare the scoring data received from the first device to the scoring data received from the third device.

13. The assistive assessment platform of claim 12, wherein the at least one processor is further configured to:
generate one or more reliability scores based at least in part on the comparison of the scoring data received from the first device and the third device.

14. The assistive assessment platform of claim 8, wherein the at least one processor is further configured to:
transmit, during the shared session, one or more assessment questions to the second device.

15. A method comprising:
receiving, from a first device, a request for an assistive assessment shared session, wherein the request comprises an indication of a selection of an assessment and data associated with a user;
generating a shared session and shared session information, wherein the shared session information comprises a code associated with the shared session and a token associated with the shared session;
transmitting the shared session information to the first device;
receiving, from a second device, a request to join the assistive assessment shared session, wherein the request to join the assistive assessment shared session comprises the code;
validating the second device based at least in part on the code;
transmitting, to the second device, the token associated with the shared session; and
hosting the shared session for the first device and the second device based at least in part on the token.

16. The method of claim 15, further comprising receiving, from the first device, scoring data associated with the assessment and the user.

17. The method of claim 16, further comprising:
receiving, from a third device, a second request to join the assistive assessment shared session, wherein the second request to join the assistive assessment shared session comprises the code;
validating the third device based at least in part on the code;
transmitting, to the third device, the token associated with the shared session; and
hosting the shared session for the first device, the second device, and the third device based at least in part on the token.

18. The method of claim 17, further comprising:
receiving, from the third device, scoring data associated with the assessment and the user; and
comparing the scoring data received from the first device to the scoring data received from the third device.

19. The method of claim 17, further comprising generating one or more reliability scores based at least in part on the comparison of the scoring data received from the first device and the third device.

20. The method of claim 17, further comprising transmitting, during the shared session, one or more assessment questions to the second device.
